(19) United States
(12) Patent Application Publication
(10) Pub. No.: US 2007/0234970 A1
(43) Pub. Date: Oct. 11, 2007

(54) Apparatus and method for drying a pet

(76) Inventors: David R. Farzan, Andover, MA (US); Jessica J. Farzan, Andover, MA (US); Jamshyd J. Farzan, Portland, OR (US)

Correspondence Address: Richard L. Sampson;SAMPSON & ASSOCIATES, P.C., 50 Congress Street, Boston, MA, 02109, US

(21) Appl. No.: 11/480,081

(22) Filed: Jun. 30, 2006

Related U.S. Application Data
(60) Provisional application No. 60/744,333, filed on Apr. 5, 2006.

(51) Int. Cl. A01K 13/00

(52) U.S. Cl. 119/850

(57) ABSTRACT

An apparatus for drying a pet includes a moisture absorbent fabric having a periphery sized and shaped to substantially cover a pet's body. An opening sized and shaped to surround the pet's neck is spaced inward from the periphery, and may include a reinforcement material and hem extending along a margin of the opening. An optional seam extending from the opening to the periphery of the fabric, may be selectively opened and closed with a hook and loop fastener.

### RELATED APPLICATIONS

This application claims the benefit of U.S. Provisional Application Ser. No. 60/744,333, entitled DOG TOWEL, filed Apr. 5, 2006.

### FIELD OF THE INVENTION

The invention is related to a device that may be used for drying and protecting pets such as dogs.

### BACKGROUND

Pets get wet for a variety of reasons. For example, after a bath or a swim, a wet dog may shake vigorously to dry itself. When a dog shakes, it creates a shower of water droplets. The droplets can come into contact with various surrounding objects. Often this shaking scatters water to places where it becomes inconvenient. The water may be spread to bathroom fixtures and mirrors, which may then have to be cleaned, electronic devices which can be ruined, and on surrounding people who find it unpleasant to be splashed.

Therefore, a need exists for a device for drying a pet which solves the above mentioned problems.

### SUMMARY

In one aspect of the invention, an apparatus for drying a pet includes a moisture absorbent fabric having a periphery sized and shaped to substantially cover a pet's body, including hindquarters. An opening sized and shaped to surround the pet's neck is spaced inward from the periphery, and may include a reinforcement material extending along a margin of the opening. A seam extends from the opening to the periphery of the fabric, which may be selectively opened and closed with a hook and loop fastener.

In another aspect of the invention, an apparatus for drying a pet includes a moisture absorbent fabric having a periphery sized and shaped to substantially cover a pet's body, while having an opening spaced inward from the periphery for encircling a pet's neck.

In a still further aspect, a method for drying a pet includes providing one of the aforementioned apparatuses for drying a pet, placing the opening around a pet's neck, draping the fabric around the pet's body, and optionally permitting the pet to shake.

### BRIEF DESCRIPTION OF THE DRAWINGS

FIG. 1. is a perspective view of an embodiment of the subject invention;

FIG. 2. is a perspective view of the embodiment of FIG. 1 shown during a representative use;

FIG. 3. is a view similar to that of FIG. 2, of an alternate embodiment of the subject invention;

FIG. 4. is a plan view of the embodiment of FIGS. 1 and 2; and

FIG. 5. is a plan view of the embodiment of FIG. 3.

### DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

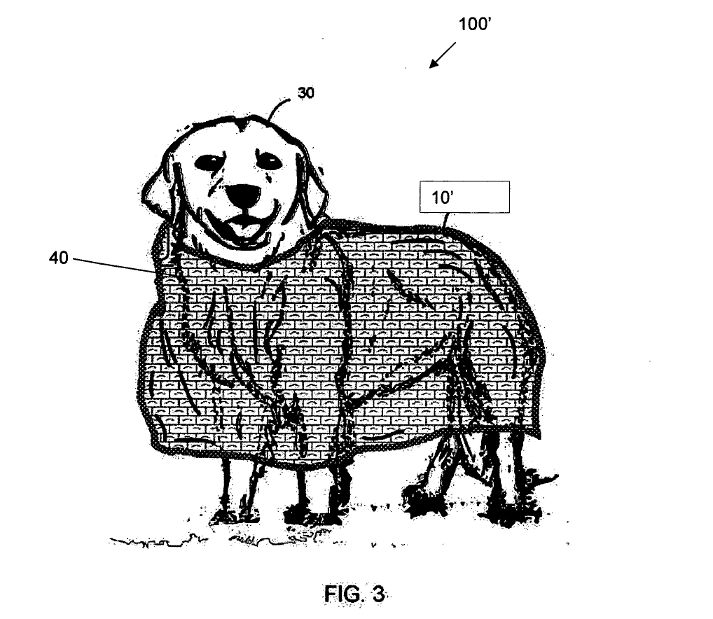

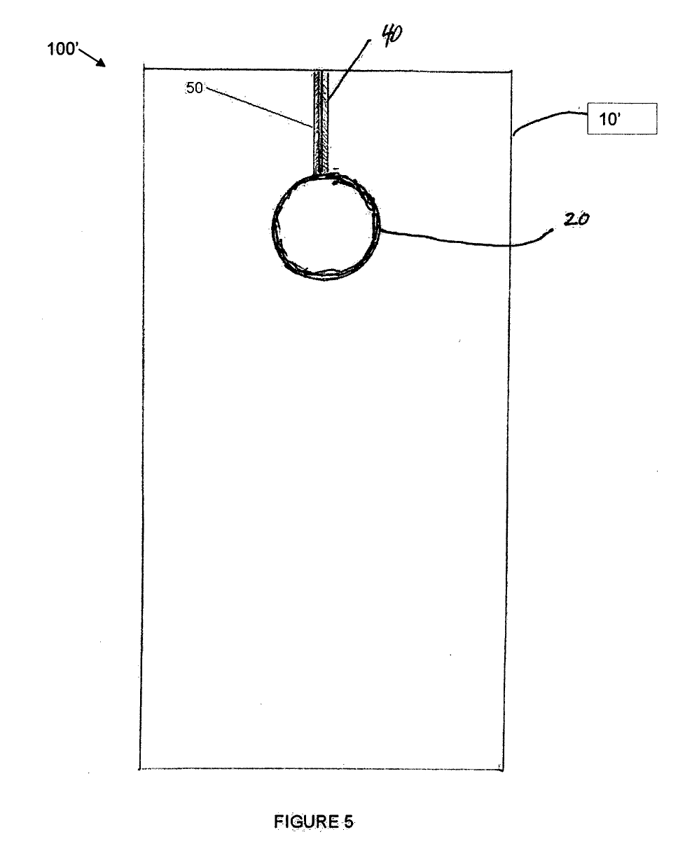

The present inventors discovered that a dog typically will not shake water off its body if its head is covered, and instead waits until a towel or the like is removed from its head before shaking. Embodiments of the subject invention address this problem by providing an absorbent garment with an appropriately sized opening for the head of a pet to pass through. The opening may optionally be provided with a fastener, (such as shown in FIGS. 3 and 5) so that the garment may be simply wrapped around the pet's neck and then secured with the fastener.

The positioning of the opening in particular embodiments is such that the garment is draped on all sides of the pet, with its neck extending through the opening. By keeping the dog's head free, this configuration tends to encourage the dog to shake while its body is substantially covered by the garment to thus capture the water that might otherwise be inconveniently sprayed. The user may also rub the garment against the dog's body to expedite drying.

Some embodiments of the invention are provided with a rectangular shape, and can easily be folded and stacked on shelves like ordinary towels for easy storage at home and in stores. Embodiments of the claimed invention can be produced inexpensively.

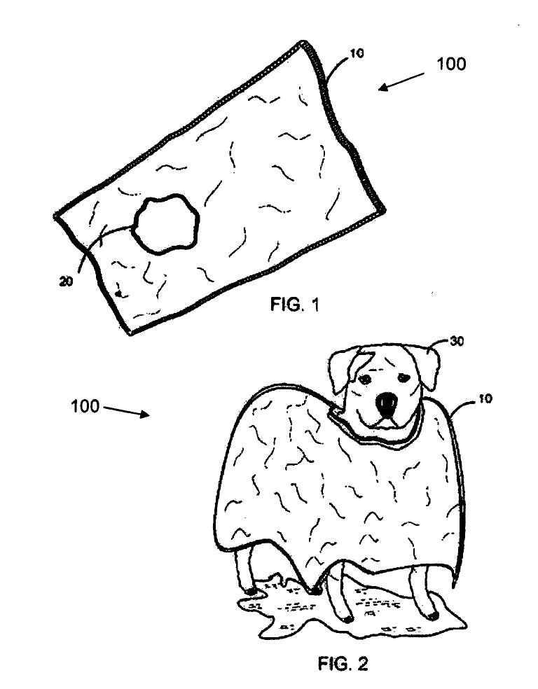

As shown in FIG. 1, an embodiment of the present invention includes a generally rectangular fabric 10 with an opening 20 sufficient for the head of a pet such as a dog to pass through. In an exemplary embodiment, the fabric 10 may be a terry cloth towel. In various embodiments, the opening 20 is optionally hemmed thereabout, to enhance durability, etc, as discussed in greater detail hereinbelow.

Referring now to FIGS. 2 and 3, embodiments of the invention may be placed on a pet such as a dog 30, with the dog's head protruding through the opening 20. As shown, garments 100, 100′ may hang around the dog 30 on both sides and front and back hindquarters while the dog 30 is drying, and optionally sized so that when worn by a pet it does not touch the ground. Various embodiments may therefore be provided with dimensions tailored to pets of various sizes. As shown, garment 100′ of FIG. 3 is substantially similar to garment 100 of FIG. 2, while including a fastener 40 as will be discussed in greater detail hereinbelow.

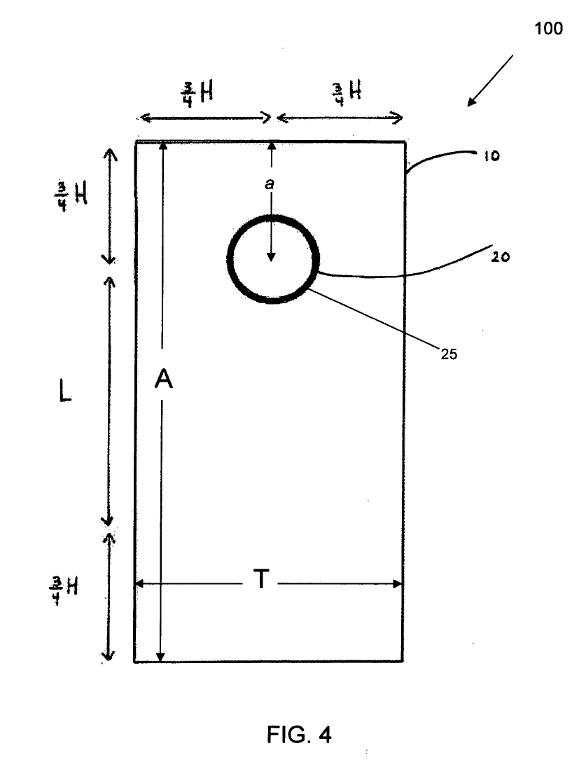

Referring now to FIG. 4, proportions of alternative embodiments of the claimed invention may be determined by the length and shoulder height of various groups of pets. For example, in a representative embodiment, an axial dimension A of the fabric 10 may be approximately one and a half times the height (H) of a pet from shoulder to ground. A transverse dimension T of the fabric 10 may be approximately one and a half times a pet's shoulder height H plus a pet's length L from the bottom of the pet's neck to the end of its spine. As also shown, the center of opening 20 may be disposed at a distance of approximately ¾ H to H from the periphery of the fabric 10 in either the transverse or axial directions. Alternative embodiments may be made available in custom sizing as well as “off the shelf” sizing.

As mentioned above, opening 20 may be provided with a hem 25, such as by folding back the fabric along the periphery of opening 20 and sewing it in a conventional manner to enhance durability, and prevent the fabric from easily unraveling or shredding when a pet such as a dog shakes vigorously. Alternatively, or in addition, hem 25 may include reinforcement, such as in the form of additional fabric such as reinforced cotton or nylon, sewn about the periphery of opening 20.

While terry cloth has been described as a suitable material for fabric 10, nominally any type of material known to those skilled in the art may be used. For example, various embodiments may include washable, highly absorbent fabrics such as cotton or cotton/polyester blends. Thermal fibers such as wool and polar-guard can be used, e.g., in northern climates to both dry a pet and to provide thermal protection for the pet. Variations for northern climates may include multiple ply construction, e.g., with absorbent fabric on the inside and thermally insulative fabric on the outside.

Referring now to FIG. 5, as mentioned hereinabove, an alternate embodiment may include a seam 40 extending from opening 20 to a periphery of fabric 10′. Seam 40 may be provided with a fastener 50, such as a zipper or a hook and loop fastener such as VELCRO® (Velcro Industries B.V., Netherlands). In other embodiments, a fastener 50 may include buttons, hooks, straps which tie together, etc.

In the preceding specification, the invention has been described with reference to specific exemplary embodiments thereof. It may be evident that various modifications and changes may be made thereunto without departing from the broader spirit and scope of the invention as set forth in the claims that follow. The specification and drawings are accordingly to be regarded in an illustrative rather than restrictive sense.

What is claimed is:

1. An apparatus for drying a pet, comprising:
a moisture absorbent fabric having a periphery sized and shaped to substantially cover a pet's body, including hindquarters;
an opening spaced inward from said periphery;
said opening sized and shaped to surround a pet's neck;
a reinforcement material fastened to said fabric, extending along a margin of the opening;
a seam extending from said opening to the periphery of said fabric; and
a hook and loop fastener disposed on opposite sides of said seam to selectively open and close said seam.

2. An apparatus for drying a pet, comprising:
a moisture absorbent fabric having a periphery sized and shaped to substantially cover a pet's body;
said fabric comprising an opening spaced inward from said periphery; and
said opening being configured to encircle a pet's neck.

3. The apparatus of claim 2, wherein said fabric covers hindquarters of the pet.

4. The apparatus of claim 2, wherein said fabric comprises a thermally insulative material.

5. The apparatus of claim 2, wherein said fabric comprises a material selected from the group consisting of cotton, terrycloth, polyester, wool, and combinations thereof.

6. The apparatus of claim 2, wherein said fabric comprises a first layer and a second layer.

7. The apparatus of claim 6, wherein said first layer comprises a moisture absorbent material, and said second layer comprises thermally insulative material.

8. The apparatus of claim 2, further comprising a reinforcement material fastened to said fabric, extending along a margin of said opening.

9. The apparatus of claim 8, wherein said reinforcement material comprises a material selected from the group consisting of cotton, terrycloth, polyester, wool, and combinations thereof.

10. The apparatus of claim 2, said fabric further comprising a hem extending around the periphery of said opening.

11. The apparatus of claim 2, further comprising a seam extending from said opening to the periphery of said fabric.

12. The apparatus of claim 11, further comprising a fastener disposed in operable engagement with said seam to selectively open and close said seam.

13. The apparatus of claim 12, wherein said fastener is selected from the group consisting of hook and loop fasteners, buttons, straps, hooks, and combinations thereof.

14. The apparatus of claim 2, wherein said fabric has a width of at least 150% of the height from the pet's shoulder to the ground.

15. The apparatus of claim 2, wherein said fabric has a length of the sum of the pet's length from is neck to the end of its spine, and 150% of the height from the pet's shoulder to the ground.

16. A method for drying a pet, comprising:
a) providing the apparatus of claim 2;
b) placing said opening around a pet's neck; and
c) draping said fabric around the pet's body.

17. The method of claim 16, wherein the placing b) comprises pulling said opening of said fabric over a pet's head.

18. The method of claim 16, wherein said placing b) comprises selectively opening and closing a seam extending from said opening to the periphery of said fabric.

19. The method of claim 18, wherein the placing b) comprises wrapping said fabric around the pet so that said opening surrounds the pet's neck and then closing the seam.

20. The method of claim 16, comprising permitting the pet to shake.
